(19) United States
(12) Patent Application Publication
(10) Pub. No.: US 2005/0261882 A1
(43) Pub. Date: Nov. 24, 2005

(54) Electric design device

(75) Inventor: Joerg Hahn, Leinfelden-Echterdingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/122,660

(22) Filed: May 5, 2005

(30) Foreign Application Priority Data
May 6, 2004 (DE) D10 2004 02 320.3

(51) Int. Cl. G06F 17/10

(52) U.S. Cl. 703/2

(57) ABSTRACT

The present invention relates to an electronic design device having a data input device, a data processing device, an output device and a data memory holding a computer-processable surface model which describes the surface of a three-dimensional object. The design device is designed so that it generates a curve and displays it on the output device. This curve includes a fixed section and a freely movable section which is connected to the fixed section at a connection point. A partial section of the freely movable section is selectable based on information entered via the data input device. After receiving a fix command, the device projects a selected partial section in a predefined direction of projection onto the surface model and fixes this projected partial section. It joins the projected partial section to the fixed section to form an extended fixed section. The device automatically ensures that at every instant the fixed section of the curve generated extends across the predefined surface model.

Priority is claimed to German Patent Application No. DE 10 2004 022 320.3, filed on May 6, 2004, the entire disclosure of which is incorporated by reference herein.

The present invention relates to an electronic design device having a data input device, a data processing device, and an output device.

### BACKGROUND

Traditionally, designers design lines on an object to be designed, e.g., a motor vehicle, by applying adhesive tape to a drawing or physical model. This adhesive tape indicates the path of the line on the surface of the object.

An electronic device used in design is described in U.S. Pat. No. 6,642,927 B1, the entire disclosure of which is incorporated by reference herein. A curve generated by the drafting device may be imported into a predefined CAD model. Vice versa, background images or design models of components may be imported so that curves may be generated.

A method for automatically applying adhesive tape to an object is known from U.S. 2003/0109946 A1, the entire disclosure of which is incorporated by reference herein. A three-dimensional electronic design model of the object is predefined. The design model defines polylines on the surface of the object to which adhesive tape is to be applied. An application device receives instructions that are a function of these polylines. It automatically applies the adhesive tape to the surface of the object as specified by the polylines.

A device and a method for designing an object three-dimensionally are known from U.S. Pat. No. 5,237,647, the entire disclosure of which is incorporated by reference herein. The device disclosed therein has two input devices which are movable and measure their movements and send them to a data processing device. As a function of the information entered via the input devices, it generates a model of the object, including curves, that is processable by a computer. It modifies the position and orientation of the model. The user specifies the position and orientation of a curve to be designed, e.g., by predefining the coordinates of an end point of a straight curve. As a function of the information entered by the user, the device generates free-form curves in a three-dimensional coordinate system, anchors them on the model, and moves them relative to the model.

### SUMMARY OF THE INVENTION

An object of the present invention it is to provide a design device, which is able to generate a curve on a computer-processable surface model of a three-dimensional object, and a design method via which a curve is generated on a computer-processable surface model of a three-dimensional object.

The design device includes
a data input device,
a data processing device,
an output device for displaying a graphic representation, and
a data memory holding a computer-processable surface model which describes the surface of a three-dimensional object.

The design device is designed so that it generates a curve and displays it on the output device. This curve includes a fixed section and a freely movable section. The path of a fixed section is fixed. The freely movable section is connected to the fixed section at a connection point.

A partial section of the freely movable section is selectable based on information entered via the data input device. After receiving a fix command, the device projects a selected partial section in a predefined direction of projection onto the surface model and fixes this projected partial section. It joins the projected partial section to the fixed section to form an extended fixed section.

The device automatically ensures that at every instant the fixed section of the curve generated extends across the predefined surface model. The user does not have to ensure via input that the curve extends across the surface model. Thus the device ensures that the user does not need to enter as much information and is able to thus avoid errors that might arise if the curve were manually modified on the surface model.

### BRIEF DESCRIPTION OF THE DRAWINGS

Below, an exemplary embodiment of the present invention is described in greater detail with reference to the drawings, in which:

FIG. 1 shows an example of system architecture of the design device;

FIG. 2 shows the representation of a curve having a fixed section and a freely movable section;

FIG. 3 shows a spatial representation of the curve in two display windows;

FIG. 4 shows a spatial representation of the curve on a surface model; and

FIG. 5 shows the release of fixing.

### DETAILED DESCRIPTION

The exemplary embodiment relates to an exemplary application of the device and method for designing motor vehicles. Designers design lines on motor vehicles for example for the following:
trim strips,
door joints, door cut-outs,
other joints,
shapes of front or tail lights.

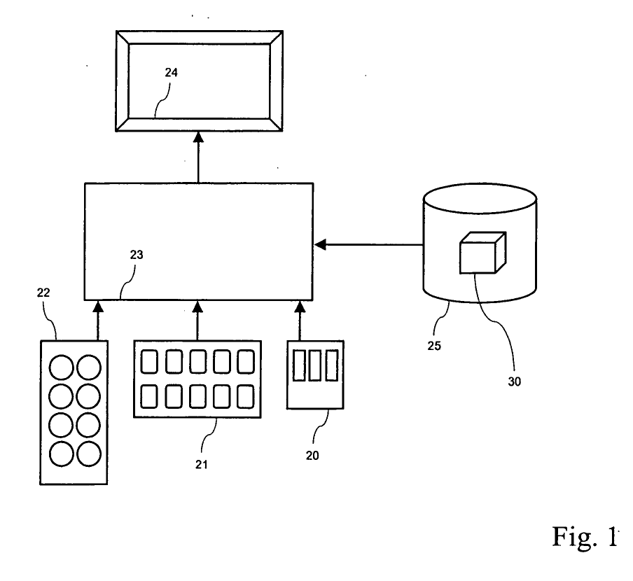

FIG. 1 shows an example of system architecture of the design device. In this example the device includes
a first input device in the form of a data processing mouse 20 having three buttons,
a second input device in the form of a keyboard 21 having keys,
a third input device in the form of a valuator 22 having eight rotatable buttons as shown in FIG. 1,
a data processing device in the form of a PC 23,
an output device in the form of a screen 24,
and a data memory 25, to which PC 23 has read access and in which a computer-processable surface model 30 of a vehicle body is stored.

In FIG. 1 the data connections between the components of the design device are shown as arrows.

In this example the data input device includes the three input devices 20, 21, and 22.

Output device 24 for generating a graphic representation generates the representation in real time. Output device 24 is preferably one of the following:
a computer screen as shown in FIG. 1, e.g., a CRT or LCD screen,
an electronic projection surface,
a digital projection device, or
a fast printer.

A plurality of these devices may also be provided as the output devices, e.g., a screen and a digital projection device.

In the example shown in FIG. 1, first input device 20 is a data processing mouse, e.g., having three buttons, which is connected to data processing device 23 via a cable or via a cordless link using infrared or radio. In an alternative embodiment, first input device 20 includes a graphics tablet having a cordless mouse and a data processing pen having a button. Position is detected by a magnetic sensor in the mouse. In this embodiment of first input device 20 also, data is transferred via cable or radio or infrared from the graphics tablet to data processing device 23.

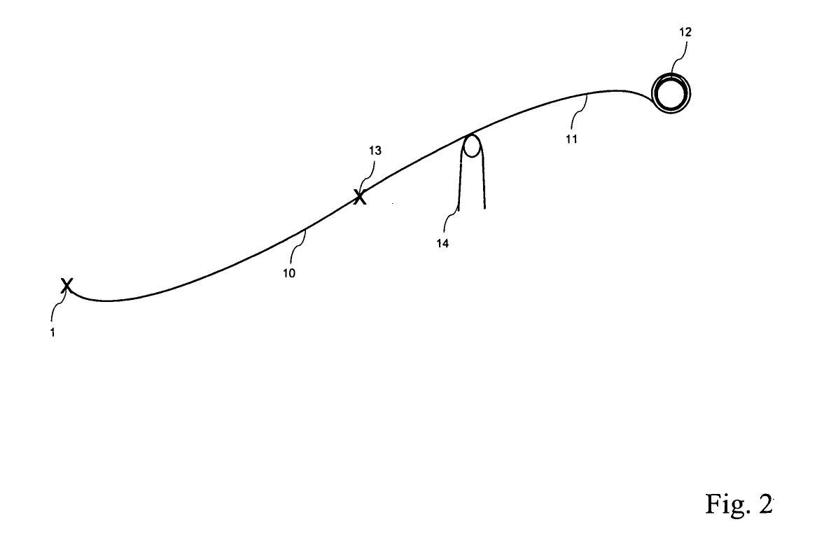

FIG. 2 shows by way of example the representation of a curve having a fixed section 10 and a freely movable section 11. Point 1 functions as the fixed starting point. Fixed section 10 extends from point 1 to point 13. Freely movable section 11 extends from point 13 to position marker 12. Point 13 functions as a connection point between fixed section 10 and freely movable section 11.

Preferably data processing device 23 displays position marker 12 and marker 14 on output device 24 using two intuitive pictograms. For example in FIG. 2 position marker 12 is shown as a roll of adhesive tape. A roll is generated using for example a plurality of circles, which are preferably arranged concentrically and have different diameters. The roll is shown so that in the representation of the curve on output device 24 freely movable section 11 emerges tangentially from the roll. Marker 14 is shown using for example an image of a pointing finger to represent the fixing function.

Position marker 12 is moved on output device 24 as a function of movements of and input via first input device 20. Position marker 12 is movable in any direction on output device 24 when first input device 20 is moved in the corresponding direction.

Depending on the information entered via one of the input devices, the device shifts a marker 14 on the representation of the curve. For example, if a button of valuator 22 is turned, marker 14 is shifted along the representation of the curve. Or the marker may be shifted along the curve by striking a specific key of keyboard 21, e.g., the arrow keys → or ←. In FIG. 2, marker 14 is shown as a finger. Herein, marker 14 may be located in fixed section 10 or in freely movable section 11.

When a second button is turned, the path of freely movable section 11 is modified, as explained in greater detail below. When one of the other buttons is turned, the spatial representation of the curve on output device 24 is modified. Valuator 22 has a plurality of buttons for modifying the representation: one for shifting the representation up or down, one for shifting it to the left or right, one for rotating it about a predefined axis of rotation, and one for zooming in or out of the representation.

According to a further embodiment, valuator 22 is a spacemouse or spaceball. When the spacemouse's button or the spaceball's ball is turned, marker 14 is shifted along the curve. Preferably, if the button or ball is moved in another direction or a switch is carried out via a key on the input device followed by a subsequent turn of the button, the path of freely movable section 11 is modified, or the spatial representation of the curve is modified, or a diagnostic tool is activated. A description of a spacemouse and a spaceball may be found at for example http://www.3dconnexion.com/products.htm (status as of Mar. 29, 2004).

Preferably further keys of keyboard 21 are also assigned. For example, the path of freely movable section 11 may be modified by striking another key; and the spatial representation of the curve may be modified by striking another key. Striking yet another key activates a diagnostic tool as described below.

Preferably the device processes numeric input via keyboard 21. When the device is in a specific mode, data processing device 23 positions position marker 12 and/or marker 14 as a function of numeric input of this kind.

The design device is preferably designed so that automatically generated freely movable section 11, which connects fixed section 10 to position marker 12, adjoins fixed section 10 in such a way that the curve is smooth. Moreover, after fixing is released the curve is still smooth. The term “smooth” is defined in Dubbel-Taschenbuch für den Maschinenbau [Dubbel Engineering Handbook], 17^{th} Edition, Springer Verlag 1990, A71, as follows: A curve is considered smooth if it may be expressed with parameters as t→r (t) with t ∈ [a, b] and r (t)=[x (t), y (t)] (in the case of a curve on a plane) and r (t)=[x (t), y (t), z (t)] (in the case of a curve in space), where x and y (and z) are continuously differentiable to [a, b] and r′(t) ≠0 for all t ∈ [a, b]. A smooth curve has a tangent at every point and has tangential continuity, i.e., the gradient of the tangent changes continuously in t. Thus at every conversion the section to be converted, which is part of existing freely movable section 11, may be described by a function t→r (t) with t ∈ [a_i, b_i] and r (t)=[x (t), y (t)] (i=1, 2, 3, . . . ). Preferably the intervals follow each other without interruption so that it is true that a_{—}1<b_{—}1=a_{—}2<b_{—}2=a_{—}3<b_{—}3 . . .

According to a further refinement of this embodiment, the design device is designed so that the curve is (n−1) times continuously differentiable at all points, including at the transition between fixed section 10 and freely movable section 11. If n=2, the curve has tangential continuity and is therefore smooth. If n=3, the curve has curvature continuity.

According to another further refinement, freely movable section 11 is a polynomial of degree n, i.e., the following is true:
r(t)=c⁰+c₁*t+c₂*t²+ . . . +cₙ*tⁿ.

Thus when conversion takes place, the selected partial section to be converted is also a polynomial. Fixed section 10 is therefore a spline of degree n. Splines are described in for example Dubbel (loc cit.), A36. Fixed section 10 in the form of a spline arose via projection and conversion from the freely movable sections which were in the form of polynomials. The positions of marker 14 at the respective instants of conversion following projection constitute data points of the spline. It is also possible for the spline to have further data points that lie between the data points that arose from the positions of marker 14. The curve is (n−1) times continuously differentiable at all points, including at the transition between fixed section 10 and freely movable section 11.

Freely movable section 11 is a polynomial of degree n. Thus freely movable section 11 is defined by n+1 vectorial parameters. In two-dimensional space these are 2*(n+1) parameters, in three-dimensional space 3*(n+1) parameters. These n+1 vectorial parameters are defined so that n+1 limiting conditions are met. These n+1 limiting conditions result from the fact that at the transition between fixed section 10 and freely movable section 11 the curve is continuous and (n−1) times continuously differentiable and extends through position marker 12. In the desired representation r (t)=[x (t), y (t)] and r (t)=[x (t), y (t), z (t)] with t ∈ [a, b] for freely movable section 11, a is defined by the functional representation of the last fixed section. This last fixed section 10 is represented as t→r (t) with t ∈ [a_(i−1), b_(i−1)] and r (t)=[x (t), y (t)] or r (t)=[x (t), y (t), z (t)]. For the desired representation t→r (t) with t ∈[a_i, b_i] of freely movable section 11, it is true that a=a_i=b_(i−1). Furthermore, r (a), r′(a), . . . , r⁽ⁿ⁻¹⁾ (t) are defined by the end of fixed section 10 and by the requirement that the transition be (n−1) times continuously differentiable. r (b) is equal to the position of position marker 12.

One remaining degree of freedom remains, namely the value for b=b_i. This is the value at which position marker 12 is reached. This parameter value b is either set to a fixed value or is determined automatically by data processing device 23 as a function of the current distance between position marker 12 and fixed section 10.

According to one embodiment, the distance between the end of fixed section 10 and position marker 12 is calculated on an ongoing basis, and current distance dist_curr is set as a proportion of distance dist_old at the instant when the last fix command was carried out. Let b_old be the value for b in the representation t→r (t) with t ∈[a_old, b_old] of last fixed section 10, and let b_curr be the value to be calculated for the representation of freely movable section 11. In that case, b_curr is calculated on an ongoing basis so that it is true that

$$\frac{b\_curr - a\_curr}{b\_old - a\_old} = \frac{dist\_curr}{dist\_old}$$

The path of freely movable section 11, which is calculated using this calculation method, approximates the path of real adhesive tape without complicated calculations being necessary.

The user may modify this automatically calculated value and thus modify the path of freely movable section 11. Using valuator 22 or by entering numerical information via the keyboard of second input device 21, the user inputs for example a scaling factor between 0.1 and 10 by which the automatically calculated value for (b_curr−a_curr) is multiplied. This embodiment requires much less effort on the part of the user than if he had to manually predefine a new value for b_curr each time. This embodiment is in particular advantageous in the case of a curve having curvature continuity (n=3), because herein the initial curvature of freely movable section 11 is predefined and may be modified by additionally entering the path of the curvature in freely movable section 11.

An alternative to representing freely movable section 11 as a polynomial of degree n is to represent it as a spline through a plurality of data points between endpoint 13 of fixed section 10 and position marker 12. The partial curve through these data points is in each respective instance a polynomial of degree n, e.g., n=3. The transition between the two polynomials of a spline at a data point is (n−1) times continuously differentiable. The data points are positioned so that the shape modification energy of the curve, which extends through the endpoint, the data points and position marker 12, is kept to a minimum. Generation of a spline of this kind is described in Dubbel, 17^{th} Edition, A36, left-hand column. In that text, the curve is described by a function y=y (x), and the shape modification energy is calculated via the method
0.5 ∫(M²(x)/(E*I)*y″(x)dx
Alternatively, the shape modification energy may also be calculated as the integral of arc length s. The data points are positioned for example so that the variation of the curvature or curvature variation is minimized. This may be expressed in formulae as follows: If k=k(s) is the curvature, a model for the curvature is minimized, e.g.,
∫k²(s)ds or ∫|k(s)|ds or generally
∫||k(s)||ds or ∫||d/ds k(s)||ds

Preferably the spline that results from repeated conversion is represented as a Bezier spline or B-spline. Both types of representation are commonly used in a wide range of CAD systems. In the case of this embodiment, the curve may be taken over into a design model or surface model without approximation or conversion.

Data memory 25 holds a computer-processable surface model 30 of a vehicle body. Data processing device 23 has read access to the data memory and thus to surface model 30. This surface model 30 has been, for example, automatically generated from a computer-processable design model such as a CAD model. Or it was generated by creating a physical model of the body using a scanner. Surface model 30 describes at least approximately the surface of a three-dimensional object. It includes a large quantity of surface elements such as triangles and/or quadrilaterals. For example the surface of the design model is lattice-like, so that finite elements in the form of surface elements arise. The finite element method is known heretofore for example from Dubbel-Taschenbuch für den Maschinenbau [Dubbel Engineering Handbook], 20^{th} Edition, Springer Verlag 2001, C48-C50. In surface model 30, a specific quantity of points known as nodal points are specified. Surface elements whose geometry is defined by these nodal points are known as finite elements.

The design device is preferably designed so that it generates a spatial representation of surface model 30 and of the curve and displays it on output device 24. It is also possible that the device displays the curve only and not surface model 30. The device displays surface model 30 and the curve relative to a Cartesian x-y-z coordinate system. The device modifies this spatial representation as a function of information entered by the user. For example, it generates a top view (in the x-y plane), a front view (in the y-z plane), a side view (in the x-z plane), a bottom view (from below in the x-y plane), or a perspective oblique view in a direction of view defined by the user. The view displayed by the device depends on information entered by the user.

Preferably the device generates freely movable section 11 so that position marker 12 lies completely in the plane of view in question and movements of an input device result only in movements of position marker 12 in that plane of view. If the user has selected for example the top view, position marker 12 is only moved in the x-y plane. Information entered via one of the input devices shifts position marker 12 perpendicular to the plane of representation, which is not visible in the plane of representation. Freely movable section 11 extends from endpoint 13 of fixed section 10, which as a general rule does not lie in the plane of representation, to position marker 12.

According to a preferred embodiment, the device generates two windows on output device 24 and displays the curve in each of these windows in a view selectable by the user. For example the curve is displayed in one window in top view, i.e., in the x-y plane, and is displayed in the other window in side view, i.e., in the x-z plane. The device generates freely movable section 11 as just described in the x-y plane, and the user shifts position marker 12 in the window having the top view. In the window having the side view, the device generates a representation which shows freely movable section 11 as a straight line. For example, if information is entered using valuator 22, the user modifies the path of freely movable section 11 in the side view, i.e., in the x-z plane. As a result of this input, the position of position marker 12 is modified in terms of depth. Herein, “depth” means the third dimension perpendicular to output device 24.

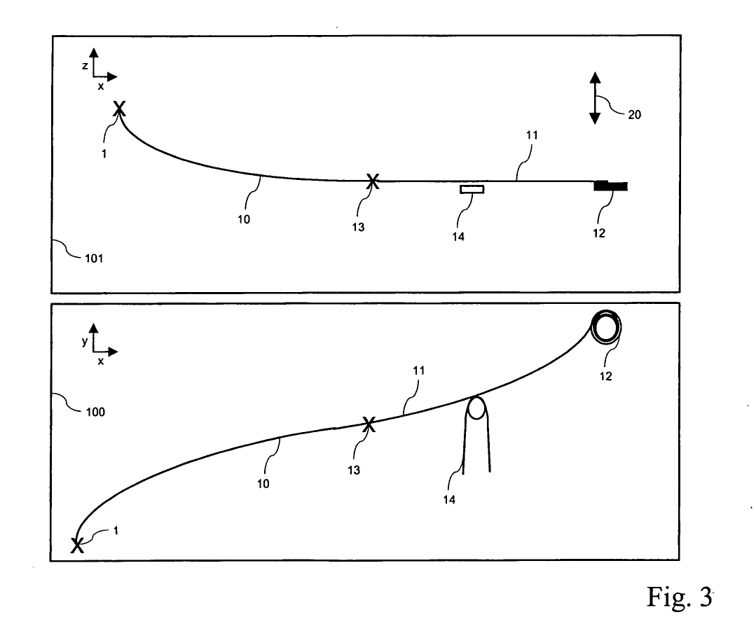

FIG. 3 shows how the device displays the curve in two windows 100 and 101 on output device 24. For the sake of clarity, surface model 30 is not shown in FIG. 3. In both windows, the device displays position marker 12, marker 14, fixed starting point 1, fixed section 10 between points 1 and 13, position marker 12 and freely movable section 11 between point 13 and position marker 12. In this example, the top view (x-y plane) is shown in window 100 and the side view (x-z plane) is shown in window 101. Furthermore, two axes of a Cartesian coordinate system are shown in each respective window to indicate which view is being displayed in which window. One of the windows is selected as the working window; in this example it is window 100. Information entered via second input device 21 and/or third input device 22 moves the freely movable curve in terms of depth, i.e., perpendicular to the plane of window 100. In window 101 this is indicated by double-headed arrow 20.

When the device receives a fix command via information entered via one of the input devices and marker 14 is located in freely movable section 11 when the fix command is received, the device selects the partial section of freely movable section 11 between marker 14 and existing fixed section 10. It projects the selected partial section in a predefined direction of projection onto surface model 30. Preferably the direction of projection is the direction of view in which an observer sees the representation of the curve on output device 24. However, the viewer may also define any directional vector relative to the coordinate system, and that directional vector is then the direction of projection.

It is possible that the partial section or a part of the partial section may also be projected in the direction of projection onto a plurality of different areas of surface model 30, e.g., if surface model 30 is convex. In this case, the device projects onto the nearest area of surface model 30.

The device converts the projected partial section into an additional fixed section and joins existing section 10 and the additional fixed section together to form a single extended fixed section. The path of existing fixed section 10 is not affected by this conversion.

Preferably the device carries out the projection as follows: A given quantity of points on freely movable section 11 between marker 14 and endpoint 13 of the existing fixed section are automatically selected. Preferably the quantity is selected so that the maximum distance between the curve and the polyline through this quantity of points is not greater than a predefined first upper limit. The greater the curvature of the partial section to be projected, the closer the selected points are to one another. These points are projected onto surface model 30.

A curve, e.g., a polygon line or a spline, is generated using the projected points. The curve is plotted as an approximation curve through the projected points. For example, it is plotted through all the projected points. Or a spline is generated which is (n−1) times continuously differentiable and is at a minimum distance from the projected points, the distance being measured using a suitable model.

As described above, projection is preferably carried out in the direction of view. The selected and the projected points then differ only with regard to their depth, which is not perceivable in the current view. The shape of the projected partial section then does not change.

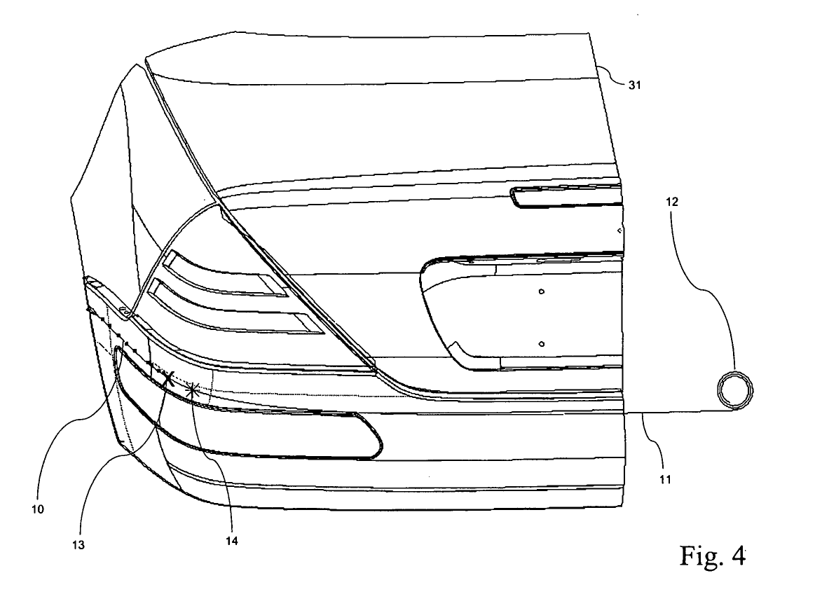

FIG. 4 shows a spatial representation of the curve on a spatial representation 31 of surface model 30. In this example, the surface model 30 of a component of a motor vehicle body is predefined. Surface model 30 and the curve are shown in the same spatial representation. Fixed section 10 extends completely on the surface of the body component, which is described by surface model 30. Marker 14, connection point 13, freely movable section 11 and position marker 12 are also shown in FIG. 4. In FIG. 4 marker 14 is indicated by an asterisk.

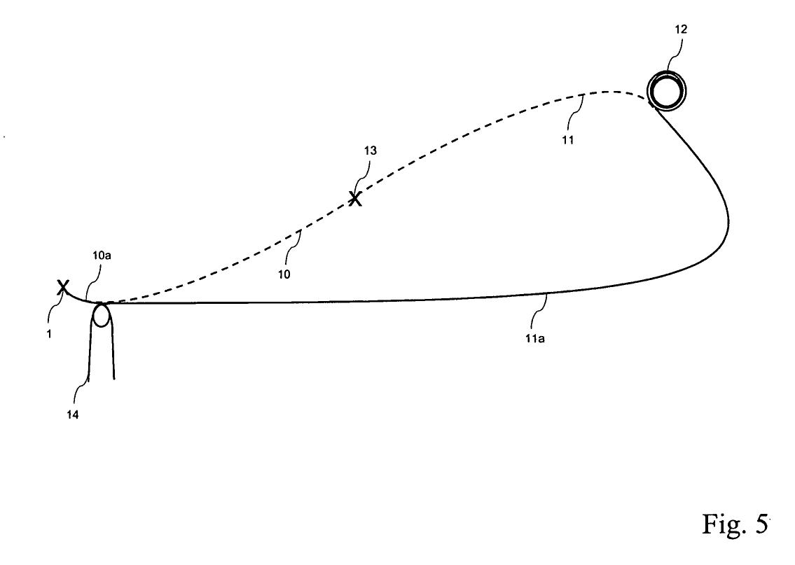

In the example shown in FIG. 5, marker 14 is located in fixed section 10 when the delete command is received. Preferably the fix command functions as a delete command if, when the fix command is received, marker 14 is located in fixed section 10. The device selects the partial section of fixed section 10 that extends between marker 14 and end point 13, which was also the starting point of existing freely movable section 11. The device deletes the selected partial section of fixed section 10 and the entirety of freely movable section 11. It generates a new freely movable section 11a, which connects marker 14 to position marker 12 and which along with remaining fixed section 10a forms a smooth curve. In FIG. 5, “old” fixed section 10 and “old” freely movable section 11 are shown as a broken line, and “new” fixed section 10a and “new” freely movable section 11a as a solid line.

In this embodiment, after fixing is released, the path of the curve changes. This matches the physical reality of adhesive tape when it is removed from the surface of an object.

1. An electronic design device comprising:
a data input device;
an output device for displaying a graphic representation;
a data memory holding a computer-processable model of a three-dimensional object; and
a data processing device generating a curve for display on the output device, wherein the curve includes a fixed section having a fixed path and a freely movable section connected to the fixed section at a connection point,
wherein a partial section of the freely movable section is selectable based on information entered via the data input device,
wherein, in response to receiving a fix command, the data processing device projects a selected partial section of the freely movable section in a predefined direction of projection onto the surface model, fixes the selected partial section, and joins the selected partial section to the fixed section to form an extended fixed section.

2. The device as recited in claim 1, wherein the direction of projection is a viewer's direction of view onto the representation of the curve.

3. The device as recited in claim 1, wherein the surface model and the curve are displayed on the output device and surface model and curve are rotatable as a function of information entered via the data input device.

4. The device as recited in claim 3, wherein the data processing device generates two spatial representations of the surface model and the curve from two different directions of view and for display on the output device.

5. The device as recited in claim 4, wherein the path of the curve is modifiable based on information entered via the data input device, and wherein the data processing device modifies both representations of the curve accordingly.

6. The device as recited in claim 1, wherein the surface model includes a plurality of surface elements, and wherein the data processing device selects a quantity of points on the selected partial section, projects each of the quantity of point onto a respective one of the surface elements, and plots a projection curve through the projected points, and wherein the projected partial section is the projection curve.

7. The device as recited in claim 1, wherein information entered via the data input device moves a position marker on the output device and wherein the data processing device generates the freely movable section so as to end at the position marker and to form a smooth transition with the fixed section.

8. The device as recited in claim 1, wherein a position of a curve marker is shiftable along the curve based on information is entered via the data input device, and wherein, when the fixed command is received at a time that the curve marker is disposed along the freely moveable section, the selected partial section is the portion of the freely moveable section between the curve marker and the connection point.

9. The device as recited in claim 1, wherein a partial section of the fixed section is selectable based on information entered via the data input device and, in response to receiving a delete command, the data processing device deletes the selected partial section of the fixed section and the freely movable partial section.

10. The device as recited in claim 9, wherein a position of a curve marker is shiftable along the curve based on information is entered via the data input device, and wherein, when the fixed command is received at a time that the curve marker is disposed along the fixed section, selected partial section of the fixed section is the portion of the fixed section extending between the curve marker and the connection point.

11. A method for designing a computer-processable curve using a data processing device, the method comprising:
providing the curve including a fixed section having a fixed path and a freely movable section is connected to the fixed section at a connection point so as to form a smooth transition;
predefining a computer-processable surface model of a three-dimensional object;
selecting a partial section of the freely movable section; and
in response to receiving a fix command:
projecting the selected partial section in a predefined direction of projection onto the surface model;
fixing the selected partial section; and
joining the selected partial section to the fixed section so as to form an extended fixed section.

12. The method as recited in claim 11, further comprising:
displaying the surface model and the curve as a representation on an output device; and
rotating the representation as a function of information entered via a data input device.

13. The method as recited in claim 12, wherein the direction of projection is a viewer's direction of view onto the representation of the curve.

14. The method as recited in claim 12, wherein two spatial representations of the surface model and the curve from two different directions of view are generated and displayed on the output device.

15. The method as recited in claim 14, wherein the two representations are displayed in two different windows of on the output device.

16. The method as recited in claim 14, further comprising modifying the path of the curve as a function of information entered via the data input device, and modifying the two spatial representations accordingly.

17. A computer program product which can be loaded directly into the internal memory of a computer and includes software sections via which a method as recited in claim 11 can be carried out if the product runs on a computer.

18. A computer program product that is stored on a medium which is readable by a computer and which has program means that are readable by a computer which cause the computer to carry out a method as recited in claim 11.
